(19) United States
(12) Patent Application Publication
(10) Pub. No.: US 2007/0263594 A1
(43) Pub. Date: Nov. 15, 2007

(54) METHOD FOR THE ADMINISTRATION OF A TELECOMMUNICATIONS NETWORK

(75) Inventors: Noemie Simoni, Savigny Sur Orge (FR); Philippe Coude, Epinay Sur Orge (FR); Antoine Boutignon, Paris (FR); Arnaud De Moissac, Paris (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 11/743,892

(22) Filed: May 3, 2007

(30) Foreign Application Priority Data
May 4, 2006 (FR) 06 51594

(51) Int. Cl. H04L 12/28; H04L 12/56

(52) U.S. Cl. 370/351; 370/400

(57) ABSTRACT

In order to ensure end-to-end quality of service in a telecommunications network, a process entrusted with managing the QoS by level is installed on each node/device. This process is capable of achieving inter-level communications and inter-device communications for a given level. A total configuration of the network can thus be determined in taking account of all the components of a network implementing the method.

### BACKGROUND OF THE INVENTION

1. Field

The disclosed embodiments relate to a method for the administration of a telecommunications network. The field of the invention is that of telecommunications networks and, more particularly, that of their administration.

It is an aim of the invention to implement an end-to-end type quality of service. Here, the term “end-to-end” refers to a custom-server relationship and/or peer relationship involving two apparatuses connected by a telecommunications network. A telecommunications network is a set of apparatuses used to connect at least two terminal apparatuses.

2. Description of the Prior Art

In the prior art, a network is considered to be a stack of levels communicating with one another, independently of the devices that physically constitute it. These levels are the following in a classic example starting from the top: the top level, the user level, the service level, the network level, and the equipment level. This modeling can be differentiated from the OSI model by the definition of its levels. The fact that the levels communicate with one another remains however perfectly present in this model. This four-layer modeling takes account of the application services (at the service level) and of the user services (at the user level). The application services are at least seen as a set of applications interfaces (also known as API) which may call upon a device to implement a service for the user. A user service is therefore defined in terms of user references and context of execution. A context of execution is defined by the set of measurements that the device called upon to implement the user service is liable to take into account. This includes the time, localization, temperature etc. The term “space-time context” is also used here.

In the prior art, QoS (quality of service) is most usually taken into account at the level of the transport network, namely the network level which is most often the same as the routing level. The service level is therefore designed to adapt to the network but not to the changes that occur at the service platform itself, for example a saturation of access to the service which will be perceived all the same by a final user and therefore by his terminal equipment as a deterioration in QoS.

In the prior art, the mechanisms based on the study of the network level by the service level, lead for example to under-utilization of the network and entail relative penalties for the TCP stream. Indeed, on the whole, this mode of management leads to slow reaction on the part of the architecture because the network is responsible for all the QoS problems at all levels of the architecture. It therefore has less time to deal properly with the streams, especially TCP streams, that cross it. Furthermore, the observation of the network response is smoothened out by the computation of an average on a sliding time-slot in order to avoid transient or oscillatory phenomena. This increases the total reaction time of the architecture (all the nodes and levels) because the reaction is proportional to an average of the activity of the network level and not to the real situation of the total network.

Other prior art approaches consider the service level to be a level totally uncorrelated from the network level. However, by reservation of application resources for example, these approaches cause the service level to be seen as a level independent of the network level and therefore to its QoS being considered as being influenced only by the elements of this level. This is false because this approach does not adapt to the different uses that a user might make of his terminal.

Finally, there are known attempts in the prior art to take account of inter-level interactions for the management of the QOS. However, these attempts ultimately propose a static and rigid organization of the total architectures and focus on the adaptation of the network level to the requirements of the service level. Such attempts are adapted to a specific type of service (voice, video, FTP or e-mail). Thus, it is very difficult to introduce a new service into the proposed architectures. This is particularly penalizing at a time when there is a very marked trend toward integration of services on the Internet.

In practice, in the prior art, the rule is to over-size a device when problems are detected. This is therefore a strategy of problem management without real visibility. In all these approaches, the problems are not resolved because they will inevitably reappear with increases in the number of users of the architecture.

### SUMMARY

The invention resolves these problems by making use of agents in the architecture of the network. These agents are programs installed on all or part of the devices forming the telecommunications network. These agents perform measurements of QoS and transmit these messages and, in the case of the most developed of them, they adapt the telecommunications network dynamically to the events that occur therein.

The disclosed embodiments relate to a method for the administration of a telecommunications network comprising several nodes, each node comprising at least one physical interface in a telecommunications network, said method comprising at least the following steps:

determining a route through the telecommunications network, such a route passing through an ordered sequence of nodes, each node being seen as an overlaying of several levels communicating with one another, two interconnected nodes communicating via their lowest level also called the equipment level, wherein said method also comprises the following steps:

the assessment of a quality of service (QoS) for each node,

the sending of a QoS request message by a sender level of a terminal node of the route,

the propagation of the QoS request message to the lower level of the sender node,

the updating of the QoS request message by each level of the node that is crossed,

the returning of the QoS request message by the lowest level of the node to the sending level, each level of the node crossed during the return applying the modifications specified by the QoS message.

In one variant of the invention, the assessment of the QoS is also done for each level of each node.

In one variant, the invention is also characterized in that, at each level of a node, the QoS management actions are implemented by an agent called an organizational pilot.

Advantageously, the invention is also characterized in that each organizational pilot (OP) may have one of the following roles:

passive role: at the time of resetting; the OP incorporates its QoS contract, during operation, the attainable, current values of the QoS are updated and threshold values of the contract are monitored, and if the OP is called upon to communicate a piece of information, it responds;

active role: at the time of resetting, the OP may distribute QoS contracts in a sub-network formed by nodes for which it is responsible or any other commands coming from a management entity, during operation it notifies all concerned parties of cases of dysfunction observed, as in the case of the passive role, it responds to different demands and updates the current values of the attainable QoS,

interactive role: the OP is therefore active, and has the capacity to interact with its counterparts at the time of resetting and in operation; it has the capacity to negotiate QoS parameters; it plays an intermediary role in an interconnection of sub-networks or between two levels,

proactive role: the OP is therefore interactive and possesses knowledge and rules enabling it to take tactical decisions to overcome a problem that it is proper to it or that comes within its network domain of responsibility.

In one variant, the invention is also characterized in that the OP roles are distributed in the network according to locations of the nodes hosting these Ops.

In one variant, the invention is also characterized in that there are defined zones/domains comprising a plurality of nodes both for a given level and for a given domain, and an OP centralizes QoS information pertaining to level and domain.

In one variant, the invention is also characterized in that, for a given node, a unique process fulfils the tasks of the organizational pilots of all the levels of the node.

In one variant, the invention is also characterized in that the QoS is assessed according to four criteria: availability, reliability, time limit and capacity.

### BRIEF DESCRIPTION OF THE DRAWINGS

The invention will be understood more clearly from the following description and from the accompanying figures. These figures are given by way of an indication and in no way restrict the scope of the invention. Of these figures:

FIG. 1 represents a telecommunications network and the levels that it comprises.

FIG. 2 is another representation of a telecommunications network, the nodes that it comprises and the levels included in these nodes.

FIG. 3 illustrates a step of the method according to the invention

FIG. 4 illustrates a QoS message.

### MORE DETAILED DESCRIPTION

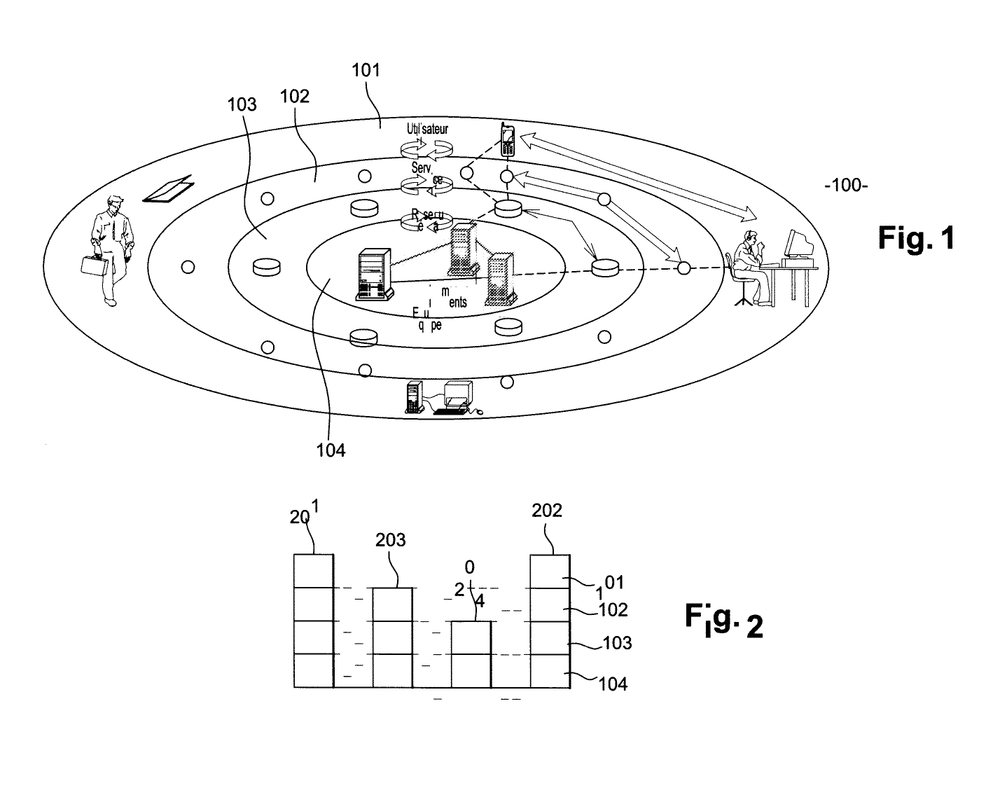

FIG. 1 shows a telecommunications network 100 seen as a stack of levels. In the description, these levels are considered to be four in number.

There is the user level 101 which corresponds to the applications used by the user of the device. This level is considered to be the highest level or the level furthest from the hardware. It corresponds to the way in which a consumer user perceives the device.

There is a service level 102 which is situated beneath the user level and corresponds, inter alia, to the software interfaces used by the applications of the user level to login to the different services such as the database, electronic messaging server and the like.

There is the network level 103 which is situated beneath the service level and corresponds, inter alia, to the communications protocols used by the higher levels.

Finally, there is the equipment level 104 which is situated beneath the network level and corresponds to the hardware proper. In the model used, the equipment level 104 covers all the equipment of the device and not only, as in the OSI model, the characteristics of a network card and electrical signals processed by such a network card. They equipment level corresponds here to the hardware capacities for information-processing and information restitution.

In practice, each device or node forming a network and/or being connected to a network comprises at least the lower two levels. The server terminal elements comprise at least the last three levels, and the user terminal elements comprise all four levels.

FIG. 2 illustrates an end-to-end communication between two devices 201 and 202 by means of the devices 203 and 204. FIG. 2 illustrates the fact that each of the devices 201 to 204 comprises at least the two lower levels.

The device 201 is, for example, a communicating personal assistant, a personal computer, a cellphone or any other communicating device. The device 202 is, for example, a file server, an electronic messaging server or the like. The fact that the server 202 has a user layer 101 can be explained for example by the fact that the server 202 has a graphic management interface or is also used as a customer station. The devices 203 and 204 are for example routers, repeaters or any other information routing/processing device in the telecommunications network 100.

In practice, the devices 201 and 202 exchange data in using communications protocols that standardize frame formats. These frames are data packets that circulate in the network. It is also said that these packets go through these devices. The data packets are not only routed but also processed by the different devices of the network.

Furthermore, for each device crossed, the packets cross at least two levels of this device. At each level crossed, the packet performs one or more actions linked to the level and to the nature of the packet.

It can be seen therefore that the QoS perceived by a user of the device depends on each level of each device crossed by the data packets from one end to the other of the link between the upper layers of the terminal devices of the end-to-end communication considered.

In practice, a QoS is negotiated either at the time of subscription to a service or at the time of connection to the network or to a server. This QoS is then guaranteed statically at each level. That is, each level is considered to be entirely responsible for the QoS of the communication. This approach leads to over-sizing the means implemented at each level for each device.

In the invention, on the contrary, each level is considered to be a communicating element of the chain of levels corresponding to the end-to-end communication. For purposes of explanation, each level shall therefore be considered to be a device provided with processing and communication means. Each level may then participate in the preparation of a QoS from end to end.

Thus in the invention, processes entrusted with the task of monitoring the maintenance of a QoS are distributed over all the levels or part of the levels of the devices forming the telecommunications network. These processes interface horizontally and vertically. In the invention, these processes are called organizational pilots or OP.

Each organizational pilot (OP) may have one of the following roles:

Passive role: at initialization, the OP incorporates its QoS contract, during operation, the attainable current values of the QoS are updated and threshold values of the contract are monitored, and if the OP is called upon to communicate a piece of information, it responds;

active role: at initialization, the OP may distribute QoS contracts in a sub-network, formed by nodes, for which it is responsible, or may distribute any other commands coming from a management entity when in operation, it notifies all concerned parties of the cases of dysfunction observed, as in the passive role it responds to different demands and updates the current values of the attainable QoS;

interactive role: the OP is therefore active and has the capacity of interacting with its counterparts, at initialization and during operation, it has the capacity to negotiate QoS parameters; it plays an intermediary role in an interconnection of sub-networks or between two levels.

proactive role: the OP is interactive and possesses knowledge and rules enabling it to take tactical decisions to overcome a problem that it is proper to it or comes within its network domain of responsibility.

In practice, an OP may have responsibility for a field of the network, i.e. it may be entrusted with the management of a certain number of devices of the network. The QoS of this field is then described and managed through this OP. This simplifies a modeling of the network and limits the streams of information exchanged between the different OPs. In this case, from the viewpoint of the end-to-end modeling of the QoS, this domain may be reduced to its boundary devices.

In one practical implementation, it may be that a device can implement only one OP type process which is then capable of managing all the levels. It is then clear that such an OP is capable of taking account of all the corresponding elements at all the levels. If several processes are involved, then they use, for communication, the standard communication modes of the processes on a machine such as the exchange files or the local network loop.

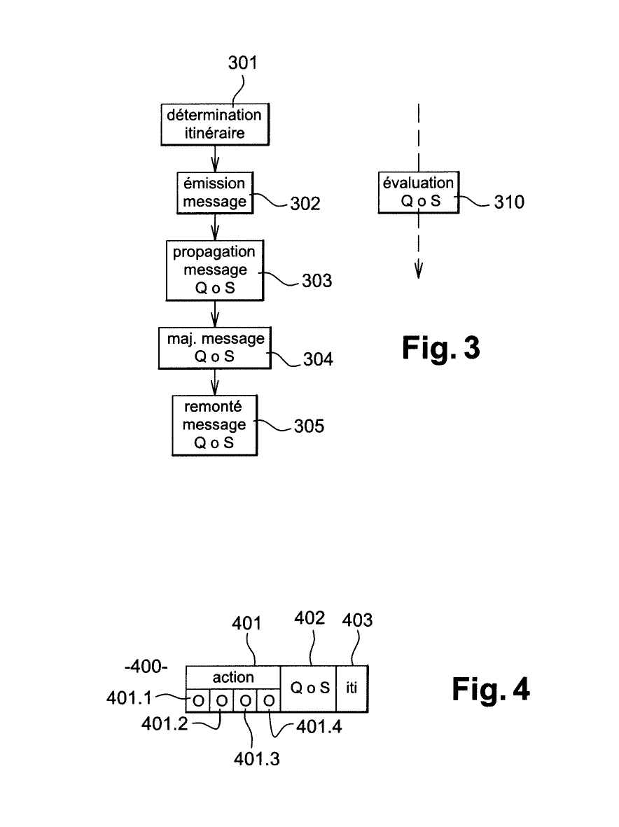

FIG. 3 shows a preliminary step 301 for determining a route. The step corresponds, for example, to an attempt to set up communication between the device 201 and the device 202. This route is therefore determined classically in resorting, for example, to a DNS type system. For the invention, it is assumed that a route takes the form of two ends, one possible end being any level whatsoever of any node whatsoever of the network.

The user who has initiated the determining of this route in seeking to make connection with a server has undertaken, in the invention, to make a QoS contract for its communications on the telecommunications network.

There are many ways of describing a QoS. For the description of the invention, a definition of QoS according to four criteria is used. These criteria are:

availability,

reliability,

time limit, and

capacity.

These criteria can be applied with varying degrees of importance to each level of each device of the telecommunications network. It can be noted here that the type of modeling of the QoS has no influence on the principle of the invention.

From the step 301, the invention therefore passes to a step 302 for preparing and sending a QoS message. FIG. 4 illustrates a QoS message of this kind according to the invention.

FIG. 4 shows that a QoS message 400 comprises at least one action field 401 and one QoS contract field 402. In one variant, the message 400 also has a destination field 403.

The field 401 itself also has four fields 401.1 to 401.4. In one implementation of the invention, these fields 401.1 to 401.4 are flags having only two possible values, 0 or 1 for example. In the invention, the field 401 has as many flag fields as a device of a telecommunications network may have levels. In the modeling of the chosen network, the field 401 therefore has four flag fields. These flag fields are updated during the processing of the QoS message. A value of 0 in this field means that the level corresponding to the flag field is not concerned, or has not been active, for the making of the QoS contract described by FIG. 402. A value of 1 this field signifies the contrary. Here, “to be active” is to modify the configuration of the level.

The field 403 comprises for example an address of the IP address type or a universal address of the URL type. The advantage of the URL type address is that it can be used to completely identify a resource and hence track back to the service level on the device 202.

The field 402 comprises, for example, a numerical level to be attained for each of the criteria describing a QoS. It is actually therefore a grade to be attained in order to comply with the QoS contract. In the present case, the field 402 comprises four grades, one for each QoS criterion.

Once the message 400 has been produced, it is sent out in the telecommunications network in order to be processed therein. In the invention, the sending can be limited to the device that has produced the message. For it may be recalled that a device/node comprises several levels communicating with one another, these levels then forming a network.

In the invention, the message 400 travels through the network by levels, i.e. it is sent out by an upper level of the device that has produced it up to the lower level of the device. In practice, the QoS message 400 may therefore very well not leave the message-producing device if its OPs comprise all the information for the processing of the QoS message. It may also happen that the message 400 is processed by several devices in the telecommunications network.

From the step 302, the invention then passes to a step 303 for the propagation of the QoS message 400. This propagation therefore consists of a downward journey through the levels of the network.

At each level, the corresponding OP reads the QoS contract, i.e. the content of the field 402 and compares it with the QoS that may be reached by its level with its current configuration. This QoS which may be reached is updated constantly through a step 310 of assessment of the QoS.

If the QoS can be attained for this level, i.e. if the grades of the contract are lower than the grades of the level, then the QoS message is simply passed to the lower level and the flag field corresponding to the level is positioned at 0.

If for this level the QoS of the contract cannot be attained, then a solution to attain the contract is sought by the OP. Such a solution consists of a modification of the parameters of configuration of the level. These configuration parameters correspond to the criteria of description of the QoS. In practice, the search for a solution depends on the nature of the OP. If the QoS message is processed by a device/level whose OP is passive, then this OP will, by way of processing, transmit this QoS message to a same level OP having more power than itself. It is observed here that the QoS message is transmitted to another device but is processed at the same level. The low-powered OPs therefore comprise, by configuration, at least one address of a higher-powered OP toward which they transmit the QoS messages that they are unable to process. In this case, the field 402 of the QoS message is modified to take account of the modifications of configuration made at the level. This modification of the field 402 enables a lower level to take account of the configuration of the upper levels. As a general rule, this modification is a lowering of the contract if the level takes charge of a part of the QoS or a raising of the contract if the level decides that the QoS will be no longer be the responsibility of the lower levels.

Another case of horizontal transmission of a QoS message is when the field 403 exits and when the current OP does not know all the payload information for the processing of the message. Such a case occurs when the use of the device 2016 to attain a service situated at a distance of several devices from the device 201. It may happen then that the OP does not have knowledge of the QoS that may be reached by the intermediate devices. This information therefore has to be obtained for example by transmitting the QoS message 400 to the confirmed level of the concerned device.

It is noted here that the content of the fee 403 may simply identify a service. The knowledge of this service and the knowledge of the QoS contract are then enough for the OPs of the network to connect the device 201 to a device 202 rendering the service identified by the field 403 and complying with the QoS specified by the field 402.

In the search for a solution, an OP of level N engages in dialog, if need be, with an OP of level N+1. Through the content of the field 401, an OP of level N knows whether an OP of level N+1 has decided not to undertake actions to fulfill the QoS contract. The OP of level N may then ask the OP of level N+1 to adapt its QoS if the OP of level N is unable to attain the QoS required by the contract transmitted through the field 402.

The step 303 is ended when the QoS message has reached and been processed by the lowest level of the telecommunications network. At this stage, the field 401 is updated by all the levels of the telecommunications network through the step 304 which is actually a sub-step of the step 303. The invention then passes to a step 305 for sending up the updated QoS message.

In the step 305, the QoS message is sent from the lowest level of the network to the highest level of the network. At each passage of a level, the concerned OP verifies the content of the flag field corresponding to its level and, if the flag field is equal to 1, it updates the configuration of its level.

The step 305 ends when the QoS message has returned and been processed at the level that produced it.

FIG. 3 also shows a step 301 for assessment of the QoS. This step is implemented permanently by all the OPs of the telecommunications network. The actions implemented in the step vary from one OP to another depending on the role of the OPs. These actions have been described during the explanation of the roles of the Ops.

The fact that this task is permanent enables the continuous adaptation of the consideration of the network. Indeed, when an OP for any reason whatsoever detects the fact that it is no longer capable of fulfilling its QoS contract, then the corresponding device produces a QoS message and launches the procedure as described in the steps 301 to 305.

What is claimed is:

1- A method for the administration of a telecommunications network comprising several nodes, each node comprising at least one physical interface in a telecommunications network, said method comprising at least the following steps:
determining a route through the telecommunications network, such a route passing through an ordered sequence of nodes, each node being seen as an overlaying of several levels communicating with one another, two interconnected nodes communicating via their lowest level also called the equipment level, wherein said method also comprises the following steps:
the assessment of a quality of service (QoS) for each node,
the sending of a QoS request message by a sender level of a terminal node of the route,
the propagation of the QoS request message to the lower level of the sender node,
the updating of the QoS request message by each level of the node that is crossed,
the returning of the QoS request message by the lowest level of the node to the sending level, each level of the node crossed during the return applying the modifications specified by the QoS message.

2- A method according to claim 1, wherein the assessment of the QoS is done for each level of each node.

3- A method according to claim 1 wherein, at each level of a node, the QoS management actions are implemented by an agent called an organizational pilot.

4- A method according to claim 3 wherein each organizational pilot (OP) may have one of the following roles:
passive role: at the time of resetting, the OP incorporates its QoS contract, during operation, the attainable, current values of the QoS are updated and threshold values of the contract are monitored, and if the OP is called upon to communicate a piece of information, it responds;
active role: at the time of resetting, the OP may distribute QoS contracts in a sub-network formed by nodes for which it is responsible or any other commands coming from a management entity, during operation it notifies all concerned parties of cases of dysfunction observed, as in the passive role it responds to different demands and updates the current values of the attainable QoS,
interactive role: the OP is therefore active, and has the capacity to interact with its counterparts at the time of resetting and during operation, it has the capacity to negotiate QoS parameters, it plays an intermediary role in an interconnection of sub-networks or between two levels,
proactive role: the OP is therefore interactive and possesses knowledge and rules enabling it to take tactical decisions to overcome a problem that it is proper to it or comes within its network domain of responsibility.

5- A method according to claim 4 wherein the OP roles are distributed in the network according to locations of the nodes hosting these OPs.

6- A method according to claim 2, wherein there are defined zones/domains comprising a plurality of nodes both for a given level and for a given domain, and an OP centralizes QoS information pertaining to level and domain.

7- A method according to claim 2 wherein for a given node, a unique process fulfils the tasks of the organizational pilots of all the levels of the node.

8- A method according to claim 1, wherein the QoS is assessed according to four criteria: availability, reliability, time limits and capacity.
